(19) United States
(12) Patent Application Publication
(10) Pub. No.: US 2023/0093508 A1
(43) Pub. Date: Mar. 23, 2023

(54) Re-fillable 2.5 gallon container to use, store, carry and dispense diesel exhaust fluid

(71) Applicant: RANDOLPH ODELL WILLIAMS, SR., UPPER CHICHESTER, PA (US)

(72) Inventor: RANDOLPH ODELL WILLIAMS, SR., UPPER CHICHESTER, PA (US)

(21) Appl. No.: 17/803,174

(22) Filed: May 24, 2019

(51) Int. Cl. B65D 25/48; B65D 55/16; B65D 25/30

(52) U.S. Cl. CPC B65D 25/48; B65D 55/16; B65D 25/30

(57) ABSTRACT

A diesel exhaust fluid use container secondary fill hole, specifically sized for a diesel exhaust fluid nozzle to aid in filling said container with the reduced possibility of introducing contaminants and meets ISO 22241-3 recommended standards for handling, storing and transporting of diesel exhaust fluid.

### FIELD OF INVENTION

Environmental, this item is related to Diesel Exhaust Fluid (DEF) storage and use. It provides a solution to get Diesel Exhaust Fluid (DEF) from a bulk container to a vehicle while adhering to the ISO 22241-3 standards. (ISO 22241-3 describes best practice recommendations and requirements for the handling, transportation, and storage of AUS 32.) Diesel Exhaust Fluid (DEF) is used in Selective Catalytic Reduction (SCR) technology to remove harmful NOₓ emissions from diesel engines.

### BACKGROUND INFORMATION

The word “invention” will be used to identify the container, spout, spout cap, fill hole and cap or lid, tethers and all other attachments used or referred to be used in and on this item.

Diesel Exhaust Fluid (DEF) is an emissions control liquid required by modern diesel engines. Diesel Exhaust Fluid (DEF) is used in Selective Catalytic Reduction (SCR) technology to remove harmful NOₓ emissions from diesel engines. It is injected into the exhaust stream. Diesel Exhaust Fluid (DEF) is never added to diesel fuel. It is a non-hazardous solution of 32.5% urea in 67.5% de-ionized water. Diesel Exhaust Fluid (DEF) is clear and colorless, and looks exactly like water. It has a slight smell of ammonia, similar to some home cleaning agents.

Diesel Exhaust Fluid (DEF) 2.5-gallon containers are sold all across America. They are portable and you can keep them in your vehicle. The problem is they are really expensive when purchased in small quantity and are a one-time use item. This means the packaging, the spout and the container are all discarded after one use. Customers pay for this cost. This is not a problem if you have a diesel vehicle and only buy 1 container every three months. But large Diesel vehicles use one gallon of Diesel Exhaust Fluid (DEF) for every 300 miles they drive, this adds up quickly. This is the reason for bulk storage at trucking companies and other business across America. However, many companies are not able to position their bulk containers for convenient vehicle access. Even when they are, many obstacles could temporarily block access to the bulk container . . . like snow, building repairs, construction or the size of some diesel engine vehicles. So they refill non refillable 2.5 retail container to carry the product to their vehicles. These containers are dirty and left with the spouts off which allow the contents to crystalize diminishing its ability for the DEF to perform properly. The spouts are often off because of the time it takes to get it off, then rethread the spouts back on. Over time it gets even more difficult to keep the spout on and prevent them from leaking as the thin container material weakens.

The spout and container mouth assemblies are intended for one time use, so they are not made of sturdy material or construction. This activity leads to an individual having a high level of contact directly with the Diesel Exhaust Fluid (DEF) and possible contamination to the container contents. As the container weakens, there is potential for leaking or even collapse. This invention is faster, cleaner, environmentally conscious, convenient and most importantly complies with ISO 22241-3 standards.

Each time an unapproved container is reused, the spout must be removed, it is then most likely placed on the ground or some other unclean surface. Contaminants can damage the Selective Catalytic Reduction (SCR) system and cause costly repairs. The individual who removed the spout now has several opportunities for direct contact. Once on the hands it can get on other surfaces, in food or in the eyes from rubbing. Some material which comes in contact with the Diesel Exhaust Fluid (DEF) could become discolored, damaged or tainted.

This invention consists of a container with a venting system that closes at all ends, a fill hole for nozzle with a lid or cap and a spout for pouring also with a cap. The container will be hard and sturdy made of polyethylene, stainless steel, nylon or some other compliant material that will not be affected by the DEF. The invention will be see through, natural color or if colored have an indicator to show when the jug is almost full. This invention will have a filter which may be located in the spout top or bottom of the spout or at the mouth of the container made of stainless steel or some other compliant material with a screen as small as 1 micron to filter the liquid as it leaves the container. The container has a fill hole on top or rear of container just big enough to receive a standard DEF nozzle and is protected by top or lid which when closed will not leak. Using a fill hole with a lid is faster because it eliminates the need to unscrew then re-attach a spout. It also limits contamination by having a hole just big enough for the nozzle to fit it. When not in use, the spout has a cap to keep air and contaminants out. This inventions method of use is safer because it limits the individuals' exposure to the Diesel Exhaust Fluid (DEF). It also offers options for storing the Diesel Exhaust Fluid (DEF) in the container in a way that won't spillover if the container is tipped over.

In addition to transporting DEF, once refilled a driver can safely transport and store Diesel Exhaust Fluid (DEF) in this container and even keep one in the vehicle for convenient access while on the road. Until now the only option is to purchase expensive 2.5 gallon containers while away, or find a truck stop that could be out of the way or in the other direction if your DEF tank runs low.

Not purchasing 2.5 gallon containers made of plastic and cardboard to use and then discard is much better for the environment.

### BRIEF SUMMARY OF INVENTION

Some embodiments of the invention are illustrated as an example and are not limited by the figures of the accompanying drawings, in which like references may indicate similar elements to be used. The terms “and/or” includes any and all combinations of one or more of the associated listed items. As used the singular forms “a”, “an” and “the” are intended to include the plural forms as well as the singular forms unless indicated otherwise clearly. It is further understood that the presence of stated features, steps, operations, elements and/or components do not preclude the presence or addition of one or more other features, steps, operations and elements. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. With the most important being the unique fill hole with cap or lid.

The present disclosure is to be considered as an exemplification of the invention, and is not intended to limit the invention to the specific embodiments illustrated by the figures or description below.

Diesel Exhaust Fluid (DEF) is a liquid which should be kept pure and enclosed to prevent contamination and crystallization. This container is used to carry Diesel Exhaust Fluid (DEF) from a bulk container to a vehicle. It meets the ISO 22241-3 standards for storing and transporting Diesel Exhaust Fluid (DEF).

Use: Invention has a covered fill hole to accept a nozzle or other filling approved apparatus to fill the invention with Diesel Exhaust Fluid (DEF) that can then be carried to a vehicle or other equipment using a Selective Catalytic Reduction (SCR) and dispensed through the inventions spout. The invention can then be refilled with Diesel Exhaust Fluid (DEF) and set aside for storage until it is needed again. When refilling this invention you will not need to remove the pouring spout.

### DESCRIPTION OF DRAWINGS

FIG. 1 is a complete picture of the container, with an exploded view of some possible components, design and locations for such. The main components are, a container, a spout and a fill hole for a nozzle. The fill hole being the most important part of this creation.

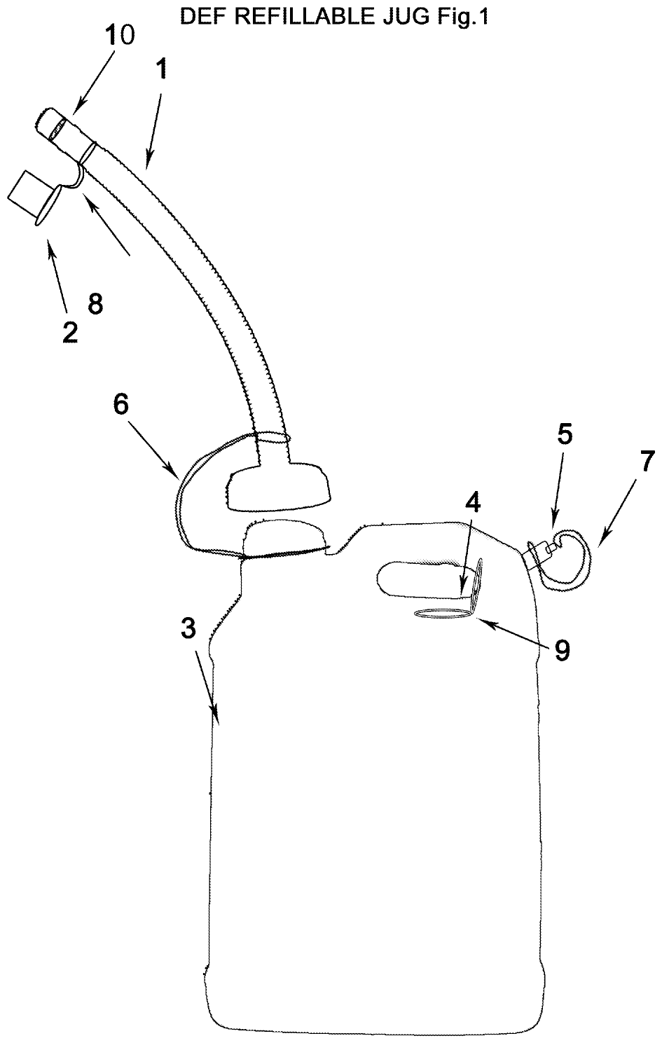

Some embodiments of the invention are illustrated as an example and are not limited by the figures of the accompanying drawings, in which like references may indicate similar elements to be used.

(1) Illustration of a pouting SPOUT for adding DEF to a vehicle. Thickness and lengths vary but the spout should be no shorter than 7 inches long and made of compliant material.
(2) Illustration of a SPOUT CAP, which when closed is spill proof
(3) Illustration of the CONTAINER which will hold a minimum of 1 US Gallon to 5 US gallons. and made of compliant material. This container will vary in size and design based on the amount of liquid it is required to carry.
(4) Illustration of the FILL HOLE, which is the most important part of this invention. This will be just big enough for a nozzle and made of compliant material. This fill hole will have a lid which screws or snaps on and will not leak after closed.
(5) Illustration of a VENT SYSTEM, which will be open for pouring to allow faster smoother pouring, then closed and sealed when storing your DEF. This will vary in size and will be made of compliant material.
(6) Illustration of TETHERS for the spout, made of stainless steel, nylon or some other compliant material not affected by DEF
(7) Illustration of TETHERS for the vent, location and size will vary, it will be made of stainless steel, nylon or some other compliant material not affected by DEF
(8) Illustration of TETHERS for the spout cap. It will be made of stainless steel, nylon or some other compliant material not affected by DEF
(9) Illustration of TETHERS for the fill hole cap. It will be made of stainless steel, nylon or some other compliant material not affected by DEF
(10) Illustration of a spout FILTER, it will be made of stainless steel, nylon or some other compliant material not affected by DEF

### DETAILED DESCRIPTION OF INVENTION

This invention was born from a need to transport Diesel Exhaust Fluid (DEF), but this invention could be used for other harmless liquids that are not regulated and uses a nozzle for dispensing. This container and all its components is assumed to use only approved material per the ISO 22241-3 standard of acceptable material to store and handle Diesel Exhaust fluid (DEF).

The container 3 made of some type of plastic or metal design is used to carry Diesel Exhaust fluid (DEF) safely while preventing contamination. It shall be natural in color or if metal have a visible strip to see the level of the contents inside and hold approximately 1.0 Gal. of liquid but up to 5.0 gallons and will vary in size based on liquid it's expected to carry. The container 3 should have a handle or some other means of picking up the container 3 to move it safely with liquid and other attachments adhered.

This container 3 will be refilled using a hole 4 in the rear, side or top just big enough for a standard size Diesel Exhaust Fluid (DEF) dispensing nozzle to limit the possibility of foreign objects being introduced. This hole 4 in the rear, side or top should be covered by a protective door, lid, flap or mechanism that is spill proof and air tight once closed. This hole 4 in the rear, side or top will also have a tether 9 to keep the protective door, lid, flap or mechanism attached.

This container shall have a vent with a cap located in the rear, top or side. It will also have a tether 7 to keep the cap for the vent attached when the vent is open for use.

This container shall have a spout for pouring with a filter 10 inside, and a tether 6 to keep the spout from reaching the ground if it needs to be removed. This spout will have a cap also tethered 8 to seal the jug when not in use.

HOW IT WILL BE USED: This invention will assist people to safely, cleanly, quickly and environmentally friendly transport Diesel Exhaust Fluid (DEF) from a bulk container to their vehicles. With a cap/lid, the Diesel Exhaust Fluid (DEF) will not spill out or be exposed to air while being moved or stored. The size of the container will be perfect for two hand holding. With a small fill hole, the Diesel Exhaust Fluid (DEF) has less chance of spilling and letting in contaminants that may easily fall into a bigger opening when filling. If something should be introduced into the container, it will be caught by the filter on the spout of the container. Once filled the Diesel Exhaust Fluid (DEF) can be carried to a vehicle and the vehicles tank can be refilled.

What is claimed is:

1. A re-usable & re-fillable closed at all ends container used to store, carry and dispense Diesel Exhaust Fluid (DEF) in a way that is ISO 22241-3 compliant. Offering a way to fill the container without removing the spout with its unique fill hole for a DEF nozzle.
Comprising of:
a. a compatible compliant container
b. a nozzle fill hole point with lid or cap
c. a spout for pouring with filter and lid or cap
d. a venting system with lid or cap
